(19) United States
(12) Patent Application Publication
(10) Pub. No.: US 2007/0162412 A1
(43) Pub. Date: Jul. 12, 2007

(54) System and method using alphanumeric codes for the identification, description, classification and encoding of information

(76) Inventor: Richard Percy, London (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/547,689

(22) PCT Filed: Mar. 3, 2004
(86) PCT No.: PCT/GB04/00896

§ 371 Date: Jan. 25, 2007

(30) Foreign Application Priority Data
Mar. 3, 2003 (GB) 0304782.6

(51) Int. Cl. G06F 17/30

(52) U.S. Cl. 707/1

(57) ABSTRACT

A method of accessing or receiving information stored in electronic or other form, the method comprising the use of alpha-numeric sub-codes, wherein the codes comprise one or more alpha-numeric sub-codes in a hierarchical structure and wherein the sub-codes and/or codes are used to identify, describe, define, classify or encode a description of the content of said information.

### FIELD OF THE INVENTION

This invention relates generally to accessing information and particularly to the encoding of information with alphanumeric codes. The alphanumeric codes enable a user to easily enter a code on a numeric keypad to access information associated with said codes. Information may include, though is not limited to, text, data, graphical or audio-visual information.

### PRIOR ART

To obtain information from the Internet usually requires the use of a Personal Computer (PC). This is done by using a keyboard to type in the full Web address in a web browser. An individual may also use an Internet search engine, by typing in the relevant key-word(s) and requesting a list of Web sites that match said keyword(s). This may produce several hundred or even thousands of purported matches, though many of these may be irrelevant.

There are an increasing number of alternative methods of accessing the Internet via devices such as mobile phones, personal digital assistants (PDA), and digital interactive TVs (iTV) and set-top-boxes (STB). However, the majority of these devices do not have an alphabetical keyboard (though sometimes an option), making it more difficult, laborious and time-consuming to type in Web site addresses using alternative methods.

It is possible to access simple text based services using devices such as mobile phones (for text messaging) and televisions (for teletext). However, in most cases, these services do not provide full access to the Internet, and the range of information available through them is comparatively limited.

In general, the state of the art suffers from several drawbacks:
(1) The normal method of accessing information on the Internet requires a PC. While increasingly popular, PCs are however far from ubiquitous around the world, and do not provide universal access. PCs also require a reasonably competent level of knowledge to operate, and are relatively expensive for many people to purchase.
(2) There are other methods of accessing the Internet, such as WAP (Wireless Application Protocol) mobile phones, PDAs, WebPads, and iTV. However, the majority of these devices do not have full alphabetical keyboards (though sometimes an option), making it more difficult and tedious to type Web site addresses using for example either an on-screen alphabet (by selecting the letters on the display), or alphanumeric keypads, where several letters are grouped on one numeric key (for example a, b, c, on the same key as the number 2). This may require a significant number of key presses to spell out certain words.
(3) Even when using a PC and a search engine to find information on the Internet, the results are not always accurate or relevant, and a long list of links can prove frustrating and time-consuming to explore. Narrowing or filtering the results may require specialist knowledge of Boolean terms or other syntax rules that most users may be unaware of.
(4) Accessing information from a standard telephone usually requires a user to navigate through numerous hierarchical menus and sub-menus to reach a particular service or option, which can be very tiresome and frustrating. There is no easy way to access a broad range of information quickly, effortlessly and in an error-free manner using a standard telephone.
(5) There is currently no method to enable an individual to quickly and easily link to related content when they read a printed article. While hyperlinks on the Internet are designed to make it easy to find related material by clicking on the link, there is nothing comparable in traditional media (such as newspapers or magazines) that enables individuals to immediately link to related information or interact in any way with the printed page.

Accordingly, there is a need in the art for a much easier and faster system that enables a user to access a Web site, or receive information from the Internet or other sources, without recourse to a keyboard and PC; to make such access simpler and quicker by using the numbers (rather than the alphabet) on a numeric and/or alphanumeric keypad, thereby requiring fewer keystrokes and reducing the chance of errors; while ensuring that the information retrieved is consistently accurate and relevant; and to provide a bridge between traditional media and the Internet with a type of link.

There are some systems that the author is aware of which enable individuals to use numbers as a way to access information, though they have significant short-comings in comparison to the method and system described herein:

Teletext

Pre-defined numbers provide access to pages of information on a TV screen via a numeric keypad on a TV's remote control.

However, Teletext information is relatively limited compared to the diverse range of information on the Internet; there are no links on a screen page to related information; there is no facility to search for specific information; the system does not have the ability for a user to personalise it; nor does it have the ability to learn from previous choices made by a user; nor the capability to use smart agents to retrieve particular information and store this for, or push this to, an individual.

WebNum

This system is based on mapping existing telephone numbers to web sites to provide access to the home page of said web sites by entering the relevant telephone number instead of the domain address or URL (universal resource locator) into a web browser. Letters or words may also be mapped to their numeric equivalent on an alphanumeric keypad, so that “FLY” is the equivalent of “359” (though this is a well established practice).

However, this system does not enable a user to pinpoint information buried within a web site; linking similar information across different web sites is not possible; it does not provide a facility for a user to personalise any settings or create a profile of preferences; nor any facility to filter information or use smart agents (as outlined above); and each ‘webnum’ exists as a separate entity, with no inter-relationship between them.

In addition, mapping words or letters to numbers reduces or precludes the ability to use any other words or letter combinations that may use the same numeric sequence on an alphanumeric keypad.

Bango Numbers

These are numbers which represent Web sites as numeric codes. The numbers vary in length, dependent principally upon the commercial cost (shorter codes being more expensive). There is no structure to the codes, as any numbers may be chosen arbitrarily by any client (provided they have not been registered by a previous client). Consequently, there is no parent-child relationship between numeric strings of different lengths, and there is no association or connection between one numeric code and another. Similar to Webnum above, the codes represent a basic alternative to the more common URL or domain name.

### SUMMARY OF THE INVENTION

A principal object of the invention is to provide an easier system for accessing information through devices with numeric (or alphanumeric) keypads, though not limited to such devices, which is substantially easier, faster, less error-prone and more contextually accurate than present methods. In addition, a further object of the invention is to provide a link between traditional media and the Internet.

According to one aspect of the present invention, there is provided a method of accessing or receiving information stored in electronic or other form, the method comprising the use of alpha-numeric codes, wherein the codes comprise one or more alpha-numeric sub-codes in a hierarchical structure and wherein the sub-codes and/or codes are used to identify, describe, define, classify or encode a description of the content of said information.

According to another aspect of the present invention, there is provided a method of navigating in a database or a network of databases, the method comprising the use of codes, wherein the codes include one or more numeric or alpha-numeric su-bcodes in a hierarchical structure, and wherein the sub-codes and/or codes are used to identify, describe, define, classify or encode a description of the content of said information, and wherein a code of n sub-codes is used to navigate to level n in the hierarchical structure.

According to another aspect of the present invention, there is provided method of storing links in electronic or other form, the method comprising storing the links to information associated with said codes, wherein the codes include one or more numeric sub-codes in a hierarchical structure and wherein the sub-codes and/or codes are used to identify, describe, define classify or encode a description of the content of said information.

According to another aspect of the present invention, there is provided a method of structuring links stored in electronic or other form, the method comprising storing the links to information associated with said codes, wherein the codes include one or more numeric sub-codes in a hierarchical structure and wherein the sub-codes and/or codes are used to identify, describe, define classify or encode a description of the content of said information

According to one aspect of the present invention, there is provided a method of encoding information, the method comprising encoding information into numeric or alpha-numeric codes, wherein the codes include one or more numeric or alpha-numeric sub-codes in a hierarchical structure.

In accordance with one embodiment of the invention, there is a system and method for encoding the descriptions of content, services, products and other information into a compressed alphanumeric code. In accordance with this method, a user need only enter a short alphanumeric code (of usually 2 to 8 digits or more) on an alphanumeric keypad to be able to access and retrieve a wealth of information, with the additional benefit that the information retrieval may be fast, accurate and contextually relevant.

The code may be of an indefinite length formed of alphanumeric digits and/or symbols, or ideally formed of numeric pairs for easier use with devices without alphabetical keyboards.

The alphanumeric codes may act as shortcuts that pinpoint Internet content and other information. The alphanumeric codes may, for example, be printed alongside articles in newspapers, appear with TV commercials, be associated with merchandise in stores, or broadcast as data streams.

The purpose is:
(1) to significantly reduce the number of keystrokes required to access information, particularly on devices with alphanumeric keypads, such as mobile phones, and thereby make the process quicker, easier and more simple;
(2) to ensure that the information requested or retrieved by a user is consistently accurate and relevant;
(3) to make it possible to access such information very easily from any communications device anywhere in the world (without recourse to a PC);
(4) to enable users to personalise information which may be either pulled or pushed to them in precisely the manner that they choose:
(5) to provide a bridge between static media (such as newspapers and magazines) and the more interactive elements of the Internet, and thereby enable a link to associated information on the Internet and other networks, which is capable of providing a more dynamic, multimedia experience.

The system and method described herein is predicated on the basis that it is significantly faster and easier for a user to enter a short numeric sequence (of say 6 digits) than to enter most web site addresses, particularly with devices without keyboards such a mobile phones. It is also likely to be less error-prone for a user to enter a short numerical sequence than an alphabetical Web address, which may often require over 40 keystrokes and has exact syntax requirements or rules.

The system and method described herein is based on the analysis, identification, description, and classification of information into Subject Terms, and encoding each Subject Term with an Alphanumeric Value. A string or sequence of Alphanumeric Values is referred to as a Data Classification Code.

While the system and method described herein allows for numeric, alphabetic and alphanumeric codes to be used, it is anticipated that codes based on purely numeric strings are likely to be the most beneficial format for use with devices that do not have alphabetic keyboards, such as mobile phones, PDAs, remote controls for TVs, satellite and cable set-top boxes, standard telephones, and Internet devices without keyboards such as WebPads. Consequently, the descriptions and examples that follow illustrate the Alphanumeric Values as numeric pairs, though the Alphanumeric Values could be of any length, and any mix of numbers, letters, and/or symbols.

The system and method provides for an unlimited string or sequence of Alphanumeric Values to define and describe any type of information or data. In many cases, it is likely that between 2 and 5 pairs of Alphanumeric Values will, in the main, provide a sufficient number of permutations to cover most types of information. (5 pairs of purely numeric values [eg: 01 23 45 67 89] are capable of generating approximately 10 billion permutations). Consequently, it may be possible to encode most information into compact alphanumeric codes of 2 to 10 digits or more.

A Data Classification Code could appear alongside printed material, for example, which would indicate, and enable access to, additional information relating to that article, topic, or advertisement. The additional information could possibly take the form of, though not limited to, text, graphical, or audio-video material, or as further links to particular Web or WAP sites.

Alternatively, Data Classification Codes could be associated with products (in information on said products or special offers. Such requests would also enable a store owner to glean important information on the level of interest in specific products or promotions.

The information that a Data Classification Code relates to may be accessed by, or sent to the user via, a variety of communication protocols or platforms, such as an SMS (Short Messaging System) text or MMS (Multimedia Messaging System), WAP or Web pages, as email, a fax, as audio, video or pictures, or converted from text to speech and read back to the user. These examples are purely illustrative and are not intended as an exhaustive range of all the possibilities.

In such scenarios, Data Classification Codes represent virtual links to information, whereby such codes are able to create an immediate bridge from one type of information to another, such as from traditional media to the more interactive dynamics of the Internet.

[Note that the term information is used throughout this document to encompass all forms of information and data, which may be of any type, entity or format.]

Specific embodiments of the invention will now be described by way of example with reference to the accompanying diagrams, whereby

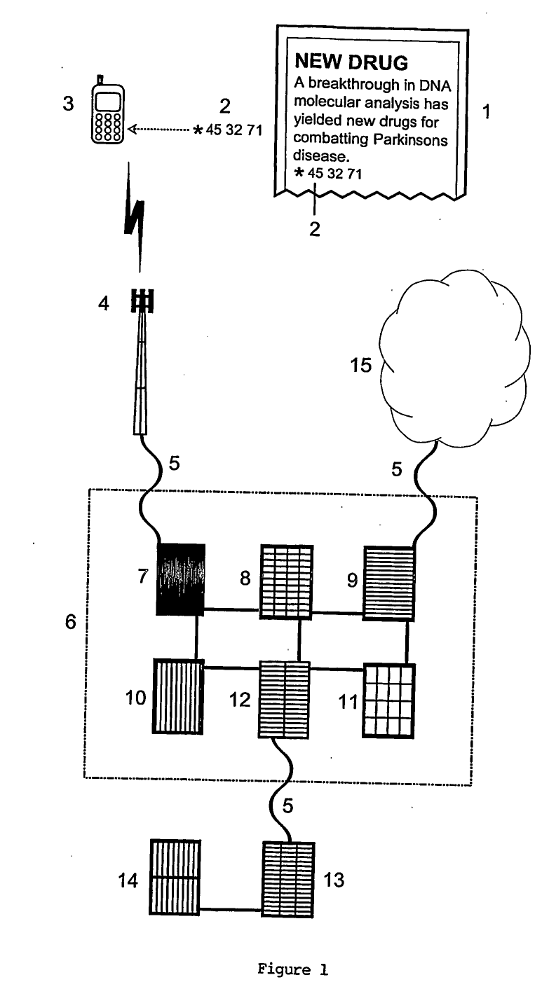

FIG. 1 is a schematic diagram illustrating one embodiment of the present invention, and

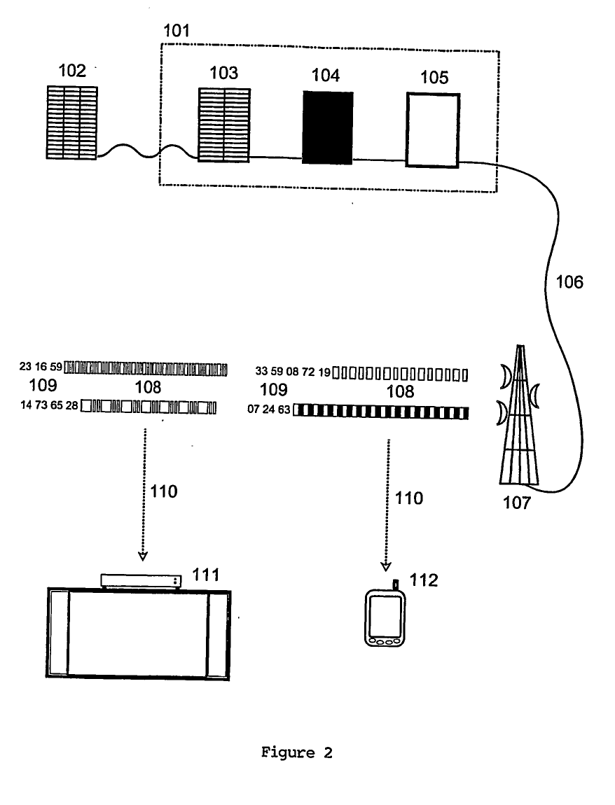

FIG. 2 is a schematic diagram illustrating another embodiment of the present invention.

FIG. 1 illustrates how the system described in this document might work.

An article in print (1) incorporates a Data Classification Code (2) at the end of the article to enable a reader to access related articles or information. The Data Classification Code is indicated with an asterix in this illustration.

The user may enter the Data Classification Code into a communications device such as a mobile phone (3), and send this via the appropriate network (4 and 5) to the network operator or service provider, where the host system resides (6). (Network connections are shown throughout the diagram as 5).

While the host system may contain many elements, the key elements for the system outlined in this document are described below.

The host's receiving server (7) recognises the Data Classification Code and parses the code through to the Links Database (8). The Links Database performs a look-up to find and match information with the same Data Classification Code. The information that is retrieved and transmitted to each user may be affected by, and dependant upon, other factors—for example, the receiving device and types of data it can manage (see below).

The proxy server (9) may cache information that has been recently requested by users to expedite access to such information.

A server database which contains the profiles and preferences of users (10) may determine the method of delivery or filter the information that is transmitted to the original user or other recipients. Intelligent agents and other types of data may be utilised to influence or improve the user's experience. In addition, the host system may be able to determine the capabilities of the receiving device and format the information accordingly for optimum benefit.

Other information may be held in servers and/or databases that relate to location, subscription charges, ad insertion, and other types of data (11).

The host system may be connected to the Internet and other sources of information (15). If the Links database does not have the appropriate information pertaining to a Data Classification Code, the code may be converted to the relevant Data Profile, and the Subject Terms contained therein may be used to search the Internet and/or other information sources.

Information that is submitted for classification is analysed by software and/or human operator(s) which refers to the Components Database (12) for the relevant Subject Terms, Classification Categories and Alphanumeric Values.

The Links Database and Components Database are also linked to, and communicate with, external Links Databases (13) and Components Databases (14) which may be separate from the host systems described above.

FIG. 2 illustrates how the system described in this document would work in a broadcast scenario.

Information that is to be transmitted across a broadcast network or system may originate from either outside the service provider's or network operator's host system (101), as illustrated by the server and/or database (102), or from within the host system, as illustrated by the server and/or database (103).

Any other data to be combined or used with a transmission may be added by further server(s) and/or database(s) (104)—for example, data relating to encryption, ad insertion, subscriptions, a user's location, and other types of data.

The complete information may then be sent to a server and/or other system (105) ready for broadcast transmission. The signals may be carried over any suitable type of network (106) to the appropriate transmission towers, satellites, cable network, or other distribution medium (107).

When the information (108) is transmitted, each distinct piece or packet of information carries a header or tag (109), which encapsulates the Data Classification Code to identify the information and any other data pertaining to it.

The information and/or data that is broadcast may be received by, or captured by (110), any suitable devices, such as TVs, set-top boxes (111) or mobile communicators (112).

The information and/or data transmitted may be broadcast so that anyone may receive it, or the information and/or data may be encrypted or filtered in such a way that ensures only certain users and/or devices are able to receive said information.

A user may also filter the information that is received or captured by his/her device(s), so that only the information that is required is presented, or retained, by the device.

Requests for information and/or data may be sent to the service provider's or network operator's host system from any suitable device over any suitable network.

### DETAILED DESCRIPTION

Overview

According to this invention, there is a system and method for the analysis, identification, description and classification of information. Information is defined and classified into Subject Terms, and each Subject Term is encoded with an Alphanumeric Value, for the purpose of encoding said information.

A methodology is used for defining and structuring information, whereby information is defined using Subject Terms. Said Subject Terms are similar to key words, except that they are language independent, and may encapsulate multiple variations of a word.

Each Subject Term provides a short definition or description of either a constituent part or the whole of the information. Therefore, a summary or profile of the information may be encapsulated in one or more Subject Terms, that when collated provide a concise description of said information or data—essentially creating a succinct profile of the information or data. When collated, the sequence of Subject Terms is referred to as a Data Profile. A Data Profile provides the appropriate reference values for the associated information or data.

A Data Profile may contain one or more Subject Terms, where each subsequent Subject Term in the sequence provides greater detail or further definition of the previous Subject Term. The first Subject Term in any Data Profile provides the relevant classification or context for the following Subject Term, and the second Subject Term provides the relevant classification or context for the third Subject Term, and so on.

An example of this increasing granularity is outlined below, where an article about “conflicts in the West Bank between Israel and the Palestinians” may be described by the following Subject Terms, each representing an increasingly narrow definition of the information:
News-International-Middle East-Israel-Palestinians-West Bank

Subject Terms are designated into tiered Classification Categories, which provide the relevant framework for allocating said Subject Terms, whereby the Subject Term in each Classification Category provides a more detailed description or definition than the Subject Term in the previous Classification Category.

Every Subject Term has an Alphanumerical Value associated with it. Consequently, Subject Terms representing a Data Profile generate a sequence of Alphanumeric Values (where there is more than one Subject Term). The alphanumeric sequence, consisting of one or more Alphanumeric Values, is referred to as a Data Classification Code. The Data Classification Code encapsulates a profile of the information in a compressed, encoded format.

Essentially, information is represented as a series of Subject Terms in a Data Profile, and these Subject Terms are encoded in a compact, alphanumerical format which results in Data Classification Codes.

Subject Terms

A methodology is used for defining and structuring information, whereby information is defined using Subject Terms and structured through a framework of Classification Categories. A Subject Term may define any type of information, including but not limited to, news, stocks and currencies, Web or WAP sites (or specific pages within them), TV and radio programmes, products and services, pictures, audio and video material, software applications, GPS grid references, or any other material, data or information.

Subject Terms can themselves be words, numbers, symbols and/or data, or any other form representing any type of information.

Said Subject Terms may be thought of as being similar to “keywords”, used commonly on the Internet for searching for information, but are crucially different in three key areas.

Firstly, Subject Terms are not dependent upon the title, content or description of the information containing such words, while keywords are generally referred to as such because of the weighting attached to that word in the material or the number of times such a word might appear. Subject Terms however are more akin to succinct definitions or concise descriptions of material—irrespective of whether the actual word appears or is referenced in the material. Subject Terms may provide a definition of a constituent part or component of the information. Subject Terms can be viewed as building blocks, which may be used to create a complete description of the information.

Secondly, Subject Terms are completely language independent, whereas keywords are typically language specific. Information on “earthquakes” may require different keywords for searching this subject in Spanish or Japanese, whereas information on “earthquakes” using the method described herein would have the same Subject Term reference whatever the language. For example, the Subject Term “Cinema” could also encompass “Movie(s)”, “Film(s)”, “Flick(s)”, “Big Screen”, “Silver Screen”, and “Pellicule” (French), “Kino” (German) and “Pelicula” (Spanish). It is possible therefore, for a wide variety of words to be associated with any one particular Subject Term. This methodology results in Subject Terms and their associated Alphanumeric Values (see below) remaining neutral and consistent across all languages.

Finally, this methodology enables a word with different definitions (for example, ‘Turkey’) to have the same Subject Term, though each Subject Term has a different Alphanumeric Value, which is determined by the word's exact meaning and context. Consequently, ‘Turkey’, the country, would have a different Alphanumeric Value to ‘turkey’, the farm animal, which again would have a different Alphanumeric Value from the cooking of a ‘turkey’. However, a keyword on it's own is unable to provide such distinction amongst different possible meanings or definitions without the benefit of either more keywords (eg: “holidays in Turkey”, making it even more laborious to type on a mobile keypad), or the use of Boolean terms (eg: “Turkey, and [or + ] holidays, not [or − ] food, not [or − ] animal”).

Classification Categories

All the words, definitions or descriptions (ie: Subject Terms) that relate to any particular information are grouped together and classified by category according to their appropriate placing within the framework for that particular topic. For example, Subject Terms that relate to the topic ‘Golf’ may include the names, locations and reviews of golf courses around the world, a list and history of professional golfers (past and present), golf equipment manufacturers and retailers, the history and origins of the game, magazines and TV programmes devoted to the sport, the major tournaments, and numerous other aspects that might relate to this topic. These Subject Terms may be weighted and classified in terms of their relevance to the main topic, their importance within a given Classification Category, and the degree of detail or granularity they represent, amongst other issues.

The Classification Categories are arranged in a series of tiered levels that relate to different depths or granular definitions of information, which may be viewed in the following terms:
Heading-Theme-Genre-Topic-Specialty-Sub-categories . . . .

Each of these Classification Categories may be viewed as relating to a different level (or depth) of information, representing increasing degrees of granularity, as illustrated below:

Illustration 1.

| Levels | Classification Categories | | | | | |
|---|---|---|---|---|---|---|
| 1 | Heading | | | | | |
| 2 | | Theme | | | | |
| 3 | | | Genre | | | |
| 4 | | | | Topic | | |
| 5 | | | | | Speciality | |
| 6+ | | | | | | Sub- |
| | | | | | | categories . . . |

The first level, Heading, provides a general overview of a subject (ie: ‘News’). The second level, Theme, provides a more narrow definition of the Heading (ie: ‘Financial News’ or ‘Local News’), and so on. Each subsequent level or Classification Category provides a more precise classification, or more detailed definition, of the information than the preceding Classification Category. Classification Categories provide a multi-dimensional structure for arranging the Subject Terms, and, importantly, provide each Subject Term with a contextual framework.

Information on the FTSE index, for example, may be represented through a hierarchy of Classification Categories (CC) and Subject Terms (ST), as illustrated below:

Illustration 2.

| CC: | | Heading | | Theme | | Genre | | Topic |
|---|---|---|---|---|---|---|---|---|
| | | News | → | International | | World | | NYSE |
| | | Weather | | National | | Markets | | Nasdaq |
| ST: | {open oversize brace} | Sportsl | | Local | | Exchanges | → | FTSE |
| | | etc. | | Financial | → | Currencies | | Nikkei |

The Subject Terms in each level or Classification Category are determined by the Subject Term in the previous level or Classification Category, such that the Subject Terms which appear in Theme will be determined by, and therefore different for, each Subject Term in the Heading category. Similarly, the Subject Terms in Genre are determined by the relevant Subject Term in the Theme category, and so on.

Consequently, an additional benefit of this method and system of classification is that all Subject Terms are intrinsically encapsulated within a contextual framework by virtue of the previous Classification Category(s) and Subject Term(s)—(excepting those in the first Classification Category).

The methodology described herein may be applied to any type of information and/or data, such that the framework created by the classified Subject Terms covers all conceivable forms and types of information, data and other material. Said framework may be unlimited in terms of both Subject Terms and Classification Categories.

Descriptions and contextual definitions of information are nevertheless represented by Subject Terms (ie: words in most cases). In order to compress said Subject Terms, and make the method of accessing information more convenient and faster for users (particularly for those with devices with numeric keypads), the Subject Terms need to be encoded in a compact alphanumeric format.

Alphanumeric Values

Once a Subject Term has been designated to the relevant Classification Category, and the appropriate weighting applied to it's relevance or importance with that Classification Category, each Subject Term may then be assigned an Alphanumeric Value.

When a new Subject Term is designated to a particular Classification Category, the next available Alphanumeric Value is generated and assigned to it. Therefore, every Subject Term in the same Classification Category is encoded with a different Alphanumeric Value.

[In the illustrative examples represented herein, each Subject Term is represented in most cases with an Alphanumeric Value of two numbers, though the Alphanumeric Values could be of any length or mix. Alphanumeric Values may contain numbers, letters, symbols and/or other data in any combination].

The Alphanumeric Value does not need to be unique for every Subject Term in the entire database, due to the structure and relationship of the Subject Terms and Classification Categories. It is only within each specific Classification Category that every Subject Term must have a different Alphanumeric Value.

Therefore, a different Alphanumeric Value is allocated to every Subject Term in each particular Classification Category. Naturally the same Alphanumeric Values may be used in different Classification Categories, but cannot be used for different Subject Terms in the same Classification Category.

An example of this follows in the illustration below, where the same Alphanumeric Values (represented by AV) are used across different Classification Categories:

Illustration 3.

| Heading | AV | | Theme | AV | | Genre | AV | | Topic | AV |
|---|---|---|---|---|---|---|---|---|---|---|
| News | 01 | | | | | | | | | |
| Weather | 02 | | | | | | | | | |
| Sports | 03 | → | Football | 01 | | | | | | |
| Business | 04 | | Cricket | 02 | | | | | | |
| Finance | 05 | | Tennis | 03 | | | | | | |
| etc. | | | F1 racing | 04 | → | Teams | 01 | | | |
| | | | Rugby | 05 | | Drivers | 02 | → | Retired | 01 |
| | | | etc. | | | Circuits | 03 | | M Schumacher | 02 |
| | | | | | | etc. | | | D Coulthard | 03 |
| | | | | | | | | | etc. | |

As illustrated above, information relating to Formula 1 racing would be encoded with the Alphanumeric Values “03 04”, while more detailed material such as information relating to F1 drivers would be encoded as “03 04 02”, and information specifically about the F1 driver Michael Schumacher would be encoded as “03 04 02 02”. This illustrates how Alphanumeric Values may be the same across different Classification Categories (and even be the same within a sequence as with ‘Genre’ and ‘Topic’ above), while the associated Subject Terms may be different, since each Subject Term resides in a separate and distinct Classification Category.

It should be noted that, in the illustration above, the next level or Classification Category after ‘Topic’ relating to ‘Speciality’ could have additional information on Michael Schumacher, such as Subject Terms on his racing history, sports statistics, sponsorship, appearances, photographs, and other such material.

As illustrated, each Subject Term provides a short definition or description of a constituent part or component of the information. Therefore, a summary or synopsis of any information may be encapsulated in one or more Subject Terms, that when collated provide a concise description of said information or data—essentially creating a succinct profile of the information or data. When collated, the sequence of Subject Terms is referred to as a Data Profile.

A Data Profile containing one or more Subject Terms would generate a sequence of Alphanumeric Values associated with said Subject Terms, as shown in the illustration below (where AV refers to Alphanumeric Values):

Illustration 4.

| CC: | Heading | Theme | Genre | Topic |
|---|---|---|---|---|
| ST: | Sports | F1 Racing | Drivers | M Schumacher |
| AV: | 03 | 04 | 02 | 02 |

A sequence of Alphanumeric Values associated with a Data Profile is referred to as a Data Classification Code, which in this example would be “03 04 02 02”.

The Classification Categories, Subject Terms, and their Alphanumeric Values are held in a database framework, which is referred to herein as the Component Database, since this database holds the components that relate to, and are used for analysing, information, and ultimately generating the appropriate Data Classification Codes for said information.

Information, or a link to information, which is encoded with a Data Classification Code is held in a database referred to herein as the Links Database, since this database holds the Data Classification Codes and the links or references that said Data Classification Codes refer to. Other data that may be pertinent to either the information, the user, the host's services, or other issues may be held in other databases, systems or software.

Analysing Information

Once the system and framework of Subject Terms, Classification Categories, and Alphanumeric Values has been created and populated (in the Component Database), it is then possible to analyse and evaluate information, such that said information may be described by the relevant Subject Terms and encoded with the assigned Alphanumeric Values, which thereby results in Data Classification Codes being generated for said information.

In order for information to be described and classified by this system, the information needs to be analysed to determine the core content, how it relates to other information, the context of the material, and the type of data, amongst other issues. In addition, the dialect or language that said information was originated in may be classified.

To elaborate on some of these aspects, there needs to be an analysis of the material in order to provide a synopsis or abstract of the information; in other words, the core content or Data Profile.

The inter-relationships between similar types of information forms part of the analysis, including an understanding of any commonality or differentiation in terms of perspective, reference, granularity, and subject weighting.

An understanding of the context of the information being analysed is also necessary. This is particularly useful in terms of reducing or eliminating ambiguity that might otherwise exist in the summary or abstract of the information.

The method and system described herein reduces the ambiguity of words by placing them within a contextual framework. For example, while the word “Turkey” has more than one meaning, the Alphanumeric Values assigned to the Subject Term “Turkey” would be different according to the relevant meaning and context. This would be determined by the Subject Terms in the previous Classification Categories, as illustrated below:

Illustration 5.

| Heading | AV | Theme | AV | Genre | AV | DCC |
|---|---|---|---|---|---|---|
| Travel | 10 | Europe | 31 | Turkey | 24 = | 10 31 24 |
| Animals | 83 | Farm | 16 | Turkey | 39 = | 83 16 39 |
| Food | 47 | Cooking meat | 21 | Turkey | 58 = | 47 21 58 |

Consequently, the Data Classification Codes (DCC) assigned to information relating to “Turkey” would reflect the context of the word or article, whether the reference is in terms of the country (10 31 24), the farm animal (83 16 39), or the preparation and cooking of a turkey (47 21 58).

If one were to use a search engine on the Internet to find information on “Turkey”, as is the current state of the art, this would probably produce results relating to all definitions of “Turkey” mixed together.

The method and system described herein should ensure that a user always receives the precise information they require, since the structure of the Classification Categories and Subject Terms maintains the contextual references for said information. This enables a user to retrieve very detailed material as easily as getting any general information.

In addition, an analysis of the type of data is helpful in terms of defining it as (amongst many possible types): raw text, a picture, audio, video, a GPS location reference point, a bar code, a product or service, a commercial transaction, or a combination of any of these, and/or other data types.

The type of data may also be determined by, or be dependent upon, the receiving device and the capabilities of the device to interpret the various types of data.

Once information has been analysed and identified, a Data Profile is generated, which describes the core material or data as a series or sequence of Subject Terms. The Subject Terms relating to said information are then matched to the Subject Terms in the appropriate Classification Categories in the Component Database. The Classification Categories provide a structured method for analysing and describing said information, in terms of identifying the scope of, and applying increasing granularity to, the subject matter.

Once the Subject Terms relating to the information have been matched to the Subject Terms in the database, the Alphanumeric Values assigned to those Subject Terms are allocated to said information. The sequence of Alphanumeric Values subsequently produces a Data Classification Code to identify and encode the information.

There may be occasions where information is analysed and a subsequent Data Profile generated, which in turn produces Subject Terms that do not exist at that point or do not have a match in the database. In such cases, the new Subject Terms are allocated to the relevant Classification Categories, and the next available or most appropriate Alphanumeric Value (that is not already allocated) in the relevant Classification Category is assigned to the new Subject Term.

Further examples of various Data Profiles and their associated Data Classification Codes are illustrated below:

Illustration 6.

| Heading | AV | Theme | AV | Genre | AV | Topic | AV |
|---|---|---|---|---|---|---|---|
| News | 01 | Environment | 34 | Logging | 85 | Indonesia | 26 |
| Sport | 03 | UK Football | 22 | Man Utd | 08 | D Beckham | 17 |
| Weather | 02 | Germany | 23 | South east | 06 | 5 day forecast | 01 |
| TV | 55 | Period drama | 67 | 18th C | 18 | France | 21 |
| Radio | 57 | Historical | 32 | America | 49 | Red Indians | 15 |
| Nature | 64 | Wildlife | 12 | India | 79 | Tigers | 36 |

When information is analysed, identified, and classified by the system, the Data Profile for said information may be logged in the Links Database with the relevant Data Classification Code. In addition, data relating to the location of the information (on the Internet or any other network, server or system), and/or other data, such as the date of origination of said information, and/or the serial number for said information (where there are multiple Data Profiles with the same Data Classification Codes), may be stored with the Data Profile and Data Classification Code. Other data to further identify, describe, classify or effect the information may also be stored with said Data Profile and Data Classification Code (see below).

The dialect or language that information is originated in may be identified to enable linguistic, cultural and/or regional choices to be met for users with specific preferences.

Information that has been identified and classified with a Data Profile and Data Classification Code may reside anywhere on the Internet and/or other networks, servers or systems, and may be stored in any local and/or remote databases.

The process of analysis, identification, description and classification of information or data may be performed at the time of the origination or creation of the information, or at any other time.

The analysis, identification, description and classification of information or data described above may be performed by either a human operator, a software program comprising computer code adapted to perform the necessary steps when run on a computer, and/or a combination of both.

Accessing Information

The method of accessing information associated with said Data Classification Codes.

A Data Classification Code may be used in numerous ways to identify, describe and/or classify information, including, but not limited to, the following examples:
Printed at the end of an article as a link to related stories
Displayed with products in stores to enable users to retrieve further information
Printed on movie posters to facilitate viewing film trailers and reviews
Broadcast with digital audio or video material to provide access to related data
Printed or broadcast with advertisements to facilitate requests for more information

When a user wishes to access information relating to a Data Classification Code, the user sends the relevant Data Classification Code to the appropriate network operator or service provider (eg: the organisation providing a service based on the system and methods described herein). The Data Classification Code is matched to information held in the Links Database with the same Data Classification Code, and said information is transmitted to the user by any appropriate method or system. Said information may be modified, filtered or altered in any way by other criteria, attributes or parameters described elsewhere in this document.

A user may be able to choose their preferred dialect or language (or “mother tongue”) for receiving information. This choice may be registered by the host system so that each user receives all subsequent information in their chosen language.

The information associated with a Data Profile and Data Classification Code may take numerous forms, including but not limited to, related information, pictures, audio, graphics or video, an index of links, a promotion or advertisement, and/or an option to purchase a product or service.

There may be occasions when a Data Classification Code is sent to the appropriate network operator or service provider, and found not to have any information with an exact matching Data Classification Code in the Links Database. In such cases, the Data Classification Code may be forwarded to the Component Database where the Subject Terms and Alphanumeric Values are stored in their constituent form. The Data Classification Code is read as a sequence of Alphanumeric Values by the Component Database, and the Alphanumeric Values are matched in the same sequence against the identical Alphanumeric Values held in the Component Database. The sequence is important since it intrinsically maps the Alphanumeric Values to the relevant Classification Categories in the Component Database. The Alphanumeric Values in each Classification Category are matched to the relevant Subject Terms with said Alphanumeric Values, which in turn generates a Data Profile. The Subject Terms in said Data Profile may then be used to search (in a similar way to keywords) for information on the Internet, and/or other networks or systems, which matches said Data Profile. The information found to match said Subject Terms and Data Profile may then be transmitted to the user. Said information which matches the Data Profile may subsequently be logged and/or stored in the Links Database with the appropriate Data Classification Code(s) and any other relevant data.

The method of accessing information associated with said Data Classification Codes described herein may be performed by either a human operator, a software program comprising computer code adapted to perform the necessary steps when run on a computer (or communications device or other apparatus), and/or a combination of both.

The user may be able to choose, amongst numerous options, how the information and/or data is transmitted, when, how often, and to which nominated devices (see below).

The system and method described herein should intrinsically reduce or eliminate information being sent to a user that is not relevant. It is possible, however, that a large number of matches might be found for certain information, such as a major news story. To enable a user to filter such information more easily, simple syntax may be used to identify the information by, amongst other criteria, a specific publisher, date, serial number and/or data type.

While the core content or Data Profile may be the same, there may be notional differences amongst information with the exact same Data Profile and Data Classification Code relating, for example, to the publishers, the date and/or time of origination, different perspectives, and/or data types. The notional differences outlined here may be described by additional identification codes and/or symbols and/or Alphanumeric Values, which are referred to herein as supplementary syntax (see below).

The system and method described herein enables information which has the same Data Profile and Data Classification Codes to be ascribed with further supplementary syntax to identify each entity according to specific attributes. Said supplementary syntax may be generated (as outlined above) according to the date, the publisher, the data type, and/or the version or serial number, amongst numerous possibilities. The serial numbers, for example, may be generated in sequence as more articles, pictures and/or other data, are added to a specific Data Profile. The method of generating and registering information with a sequential identification may also enable the broadcast or retrieval of information in a way that ensures only a particular edition (eg: the latest version) of said information is presented or accessible to the user, if so required.

It would also be possible for publishers using the system and method described herein to code the publication for an advertisement for example, and thereby track the responses to such advertisements or promotions across various publications or other media. In the illustration below, DCC represents the Data Classification Code and the Alphanumeric Values appearing after the symbol, “#” in this example, indicates supplementary information, such as the publisher's identity, and/or serial number of the information, and/or date, and/or data type.

Illustration 7.

| DCC | Data Profile |
|---|---|
| 01 01 07 35 #02 04 -176 | News - World - Russia - Chechnya # NY |
| | Times (article 176) |
| 27 03 14 #06 59 /101102 | Entertainment - USA - Disneyland # LA Times |
| | (10 Nov. 2002) |
| 15 08 61 29 #13 47 :6 | Music - Rock - U2 - Joshua Tree # WKFM |
| | (audio) |

Such supplementary syntax and/or Alphanumeric Values may be logged, printed and/or broadcast, or disseminated in any other way, with the appropriate information. Such syntax and/or Alphanumeric Values may or may not be visible or relevant to the user, and may be used by the system for logging purposes for example without necessarily being seen by the user. Additional supplementary syntax may be used to delineate other attributes or criteria.

The system and method described herein also enables a user to determine the parameters for retrieving and/or receiving and/or forwarding information.

A user may employ simple syntax to specify particular dates that they may wish the information to relate to, or specific dates and/or times for the information to be sent. A user may request, for example, a weather forecast or a TV schedule for several days ahead, or an article or video clip relating to past events. This method could also enable a user to specify dates from “today”, indicated by “0”, followed by “+” to represent going forward, or “−” to represent going back, a specified number of days.

Examples of some of the parameters that may be applied are illustrated below (where DCC represents the Data Classification Code and the symbol “*” indicates the user's chosen parameters).

Illustration 8.

| DCC | Data Profile | Suffix definition |
|---|---|---|
| 03 08 14 06 *0+5 | Weather - Europe - | 5 day forecast |
| | France - South | |
| 01 04 16 07 *0−28 | News - Finance - | Past month |
| | USA - Interest rates | |
| 01 04 03 03 *0 09:00 | News - Finance - | Every day at 9 am |
| | Exchanges - FTSE index | |
| 13 52 07 *0+7 fax | TV - Homes - | Next 7 days by fax |
| | Gardening programs | |
| 29 m4 j3+4 *0 08:00 | Traffic - M4 - Junctions | Every day at 8 am |
| | 3 & 4 | |

This method enables the broadcast and/or retrieval of information in such a way that only information within a specified date or period, and/or a particular type of information, amongst other possibilities, is presented and/or transmitted to the user.

Additional attributes and/or definitions may be applied through the use of other symbols, syntax and/or parameters.

The format of the information sent to a user may be influenced by, amongst other issues, the user's device, the distribution medium and/or the user's preferences or profile settings. The system and method described herein encompasses the ability for the system to interrogate the user's device to determine the type of screen and other capabilities of the receiving device, such that the information may be formatted in an optimum manner to suit the performance and capabilities of the recipient's or receiving device.

The Data Classification Codes and/or the associated Data Profiles and/or information may be saved or stored by a user for future use or reference. The Data Classification Codes and/or the associated Data Profiles and/or information may be sent or distributed by a user to other devices or users.

The Data Classification Code and/or information that is retrieved by and/or transmitted to a user may be filtered, modified or altered by settings and/or other criteria that the user and/or third parties may create to enhance, restrict or change the information. The user may create their own preferences and profiles for receiving information for example. Said Data Classification Codes and/or information may also be filtered, modified or altered by software, applications and/or agents that the user and/or third parties use to enhance, restrict or change the information.

The Data Classification Code and/or information that is retrieved by and/or transmitted to a user may have other data applied to it that may modify said information in terms of the attributes and/or parameters applied by such data.

The Data Classification Code and/or information retrieved by and/or transmitted to a user may have geographical reference data applied to it that may determine the type of information provided. The geographical reference data may filter and/or modify said information to ensure the optimum contextual value for a given location.

For example, information relating to weather, TV or cinema listings would be more useful and relevant to the user if the information transmitted was filtered such that it only applied to the area where the user was at the time the information was requested. The geographical reference filter and/or other settings may be overridden or changed by the user and/or third parties if other information (perhaps relating to other areas) is required.

The Data Classification Code and/or information retrieved by and/or transmitted to a user may be encrypted, scrambled or disguised in some form to preserve security, privacy, and other issues.

The Data Classification Code and/or information retrieved by and/or transmitted to a user may have some form of digital rights management or similar system in place to protect the copyright of the owners, authors and/or originators of the information or data being accessed, transmitted and/or distributed.

The Data Classification Code and/or information retrieved by and/or transmitted to a user may have a fee or some form of fiscal charge applicable.

The Data Classification Code and/or information retrieved by and/or transmitted to a user may have a limit or restriction or other parameter applied regarding, for example, it's use or re-use, and/or distribution, and/or time delineation, amongst other issues.

The Data Classification Code and/or information retrieved by and/or transmitted to a user may be a commercial transaction, normally, but not exclusively, involving some form of financial exchange, compensation, or remuneration.

The Data Classification Code and/or information retrieved by and/or transmitted to a user may be paid for by the user and/or another entity, such as, for example, the originator, a distributor, a sponsor or an advertiser, amongst numerous possibilities.

The Data Classification Code and/or information retrieved by and/or transmitted to a user may have other forms or types of data restrict, filter, alter, modify or enhance said Data Classification Code and/or information.

The Data Classification Codes may refer to information and/or data on the Internet, other servers, systems and/or networks or devices, distributed by wired and/or wireless networks, broadcast with data, audio and/or video programming, and/or distributed by any other means, network or system.

A user may input a Data Classification Code into a communication device, computer or other apparatus, or identify a Data Classification Code if already stored therein, say the Data Classification Code to a voice recognition system or human operator, or transmit the Data Classification Code via any other means.

The Data Classification Code may be entered and/or stored in a device, and when said Data Classification Code is broadcast or transmitted by any other means to said device, the device may identify said Data Classification Code, in the broadcast stream for example, and capture and/or store the information which is associated, broadcast and/or transmitted with said Data Classification Code. In such a scenario, a user's device may only capture and/or store the information said user has selected and ignore the rest.

The Data Classification Codes and/or words, numbers, abbreviations, symbols or any other data, may be entered and/or transmitted via any suitable apparatus including, although not limited to, a numeric keypad, a computer keyboard, a hand-writing recognition system and/or voice-recognition system.

Navigating Data Classification Codes

The method and system described herein enables simple and easy navigation within the framework of Classification Categories, Subject Terms and Alphanumeric Values.

The method and system described herein provides a lucid parent-child relationship within Data Classification Codes, so that abbreviating or extending the string of Alphanumeric Values (in a Data Classification Code) will simply provide different levels of information regarding the same subject matter.

A user could shorten a Data Classification Code by, for example, excluding the last pair of Alphanumeric Values, thereby eliminating the last Classification Category, which would raise the Data Profile up one level and this would widen the scope of the material. This may be accomplished with any sequence of Alphanumeric Values, on the basis that the Alphanumeric Values which are excluded are at the end of any sequence or string (representing the most granular Classification Category). This would enable a user to increasingly expand the scope of any information (where appropriate) as the Data Classification Code becomes incrementally shorter.

A user may also wish to explore and discover other possible topics or Subject Terms at any point in a Data Classification Code. This may be achieved through the use of a consistent Alphanumeric Value, such as “00”, representing the ‘Index’ at each level or Classification Category. The Index may display the list of Subject Terms (and if necessary their assigned Alphanumeric Values) accessible in the relevant Classification Category. Therefore, a user may find out about other similar content (under the previous Classification Category), but with different Subject Terms, by substituting the last Alphanumeric Value in a Data Classification Code with the Alphanumeric Value “00”, which would present the user with an Index of the available (and alternative) Subject Terms in that particular Classification Category.

A user may equally drill down by increasing the sequence of Alphanumeric Values in a Data Classification Code to access more detailed or granular information. A user who may wish to explore particular information more deeply may enter the Alphanumeric Value “00” at the end of any Data Classification Code, which would result in the user being presented with an Index listing the various Subject Terms accessible in the next level or Classification Category. This exercise may be repeated to enable increasingly narrow definitions of information to be explored, on the basis that additional levels or Classification Categories with Subject Terms exist.

This methodology differs from any other systems that currently use numeric codes to enable users to access information (such as Teletext, WebNum or Bango), where shortening or lengthening a numeric code results either in a code which no longer has any meaning to the host system, or in a code which may equate to information that has no relevance to, or is entirely different from, the information associated with the original code.

Data Classification Codes may also be modified using simple syntax, or any other means, to qualify, alter and/or filter the relevant Data Profile. The syntax may, for example, add or remove a Subject Term that is applicable to the preceding Subject Term. The syntax may be entered by using a keypad, keyboard, and/or through a “Menu” options on the screen, or any other suitable method. Examples of this are illustrated below:

Illustration 9.

| DCC | Data Profile |
|---|---|
| 26 17 35 09+14 | Travel - UK - London Tube - Central & District lines |
| 59 08−13 | Film - Comedy without violence |

In addition to Alphanumeric Values, a user may enter a word, text, number, abbreviation, data and/or any other character or symbol, and send or submit this to the host system as a request for information either as part of, or separately from, a Data Classification Code. The host system may execute a search to find a match between said text, symbol, and/or data, and any of the Subject Terms that may have a reference to said text, symbol, and/or data. This may be executed by utilising any Alphanumeric Value or Data Classification Code as a contextual platform from which said request may be initiated, or without the benefit of any Alphanumeric Value or Data Classification Code as a springboard. Examples of this are illustrated below, where the Subject Terms that match the search word, symbol and/or data are shown in the Data Profile, together with the relevant Subject Terms from the Classification Categories not specified in brackets:

Illustration 10.

| DCC | Data Profile match |
|---|---|
| 03 Paris | Weather - (Europe - France) - Paris |
| 01 08 Oracle | News - Industry - (USA - Technology - Software) - |
| | Oracle |
| m4 j3+4 *mms | (Traffic) - M4 - Junctions 3 & 4 * send as mms |

When there is more than one possible match, the system may display a list of matching Data Profiles which may contain the relevant word, text, number, abbreviation, or symbol. The user may then select the appropriate Data Profile(s) they wish to use and transmit said Data Profile(s) and/or associated Data Classification Code(s) to the host system, which would provide the information relating to said Data Profile(s) and/or Data Classification Code(s). Words, numbers, abbreviations and/or symbols may also be used to define the way that information is transmitted to and/or received by the user.

It may be necessary to include a prefix, and/or other identifier, with each Data Classification Code to ensure that said code is identified as a Data Classification Code, and not some other alphanumeric code for a different purpose, by the receiving or host system of the service provider or network operator. The prefix, and/or other identifier, may be a symbol, header, tag and/or code (or any other data) to identify the Data Classification Code as such, and to ensure that the code is correctly recognised by the service provider or network operator's systems as a Data Classification Code. This prefix, and/or other identifier, may be stored and sent by the device, which automatically attaches said prefix, and/or other identifier, whenever a Data Classification Code is sent, and/or may be entered by the user, and/or retrieved and/or transmitted by any other appropriate method in order to enable the identification of the Data Classification Code.

The interaction between the transmission of the Data Classification Code and the reception of the information and other data or interaction may occur with any communications device over any type of network and/or system. The Data Classification Code may be sent from any communications device, including but not limited to, a PC, mobile phone, TV or STB, PDA, WebPad, Net Appliance, or standard telephone. Similarly, the information or other data may be transmitted to and/or received by any device capable of receiving said information and/or data, over any type of system and/or network.

### SUMMARY

The method and system described herein enables the creation of detailed and very precise Data Profiles for any type of information. Said Data Profiles are represented by Subject Terms which are held in a structured hierarchical framework of Classification Categories. Each Subject Term has an Alphanumeric Value associated with it.

Consequently, the Subject Terms represented in any Data Profile will generate a sequence of Alphanumeric Values. The Alphanumeric Values enable the information represented by said Data Profile to be encoded into very compact, alphanumerical sequences. Said alphanumeric sequences are referred to as Data Classification Codes.

The Data Classification Codes represent links to, and/or tags for, additional information and/or data and/or other systems. The Data Classification Codes may act as a bridge between static content in print (such as newspapers and magazines) and more interactive mediums, such as the multimedia dynamics of the Internet.

The Data Classification Codes represent simple shortcuts for pinpointing Internet content and/or other information.

The system and method described herein enables the retrieval of virtually any information, which may be easily linked to and accessed from other information, such as material in print for example, with the minimum of keystrokes, thereby making it easier, quicker and more simple to retrieve such information.

This method dramatically reduces the likelihood of error, and ensures significantly more accurate results.

It enables the reception of specific information from broadcast data, by enabling a user to enter and store Data Classification Codes relating to particular information and/or data in a device. The device may capture any information and/or data which is broadcast with the associated Data Classification Codes. The codes and data may be broadcast as part of the main channel or as part of a side or sub channel-such that the information and/or data may relate directly to the content being broadcast or may be independent of, and separate to, the audio/visual content being broadcast.

The system negates the requirement for a PC or a normal alphabetical keyboard to access Web-based or other information, and enables any communications device to easily retrieve or access any information over any network.

It is to be understood that the embodiments described above are preferred embodiments only. Various features may be omitted, modified or substituted by equivalents, without departing from the scope of the present invention.

1-43. (canceled)

44. A method of accessing or receiving information stored in electronic or other form,
the method comprising the use of alpha-numeric codes,
wherein the codes comprise one or more alpha-numeric sub-codes in a hierarchical structure and wherein the sub-codes and/or codes are used to identify, describe, define, classify or encode a description of the content of said information.

45. A method according to claim 44, wherein a code comprising n sub-codes provide for n levels in the hierarchical structure.

46. A method according to claim 44, wherein the sub-codes are numeric.

47. A method according to claim 44, wherein said sub-codes comprise a two digit code.

48. A method according to claim 44, wherein all of said sub-codes have the same data structure.

49. A method according to claim 44, wherein the codes include a sequence of one or more of said numeric or alpha-numeric sub-codes.

50. A method according to claim 47, wherein the codes comprise a sequence of two digit sub-codes.

51. A method according to claim 44, wherein said codes are stored together with links in electronic or other form, said links being usable for accessing or receiving said information.

52. A method according to claim 44, wherein the sub-codes and/or codes are used to navigate to desired or associated links or information.

53. A method according to claim 44, wherein each of the sub-codes at each level of the hierarchical structure is associated with a certain subject-term.

54. A method according to claim 44, wherein the codes consist solely of a combination of said sub-codes.

55. A method according to claim 44, wherein information assigned a particular code relates either:
i) to the subject-term associated with said particular code if the code includes a single sub-code; or
ii) to all subject-terms associated with all sub-codes of said particular code if the code includes more than one sub-code.

56. A method according to claim 44, wherein one or more of said codes are distributed together with information and/or products.

57. A method according to claim 44, wherein an indexing function is provided at each level of said hierarchical structure.

58. A method according to claim 57, wherein at each level of said hierarchical structure data related to subject-terms associated with the sub-codes are available upon entering a particular sub-code.

59. A method according to claim 53, wherein one or more of the sub-codes are converted into the associated subject-terms.

60. A method according to claim 44, wherein codes complemented by subject-terms are used to search for, access or receive information.

61. A method of navigating in a database or a network of databases, the method comprising the use of codes,
wherein the codes include one or more numeric or alpha-numeric sub-codes in a hierarchical structure, and wherein the sub-codes and/or codes are used to identify, describe, define, classify or encode a description of the content of said information,
and wherein a code of n sub-codes is used to navigate to level n in the hierarchical structure.

62. A method of storing links and/or structuring links stored in electronic or other form,
the method comprising storing the links to information associated with said codes,
wherein the codes include one or more numeric sub-codes in a hierarchical structure and wherein the sub-codes and/or codes are used to identify, describe, define classify or encode a description of the content of said information.

63. A method of retrieving or receiving information from a database or a data network using the methods according to claim 44.

64. A method of encoding information, the method comprising encoding information into numeric or alpha-numeric codes, wherein the codes include one or more numeric or alpha-numeric sub-codes in a hierarchical structure.

65. A method according to claim 62, wherein a code comprising n sub-codes provide for n levels in the hierarchical structure.

66. A method according to claim 61, wherein said sub-codes comprise a two digit code.

67. A method according to claim 62, wherein said sub-codes comprise a two digit code.

68. A method according to claim 61, wherein all of said sub-codes have the same data structure.

69. A method according to claim 62, wherein all of said sub-codes have the same data structure.

70. A method according to claim 61, wherein the codes include a sequence of one or more of said numeric or alpha-numeric sub-codes.

71. A method according to claim 62, wherein the codes include a sequence of one or more of said numeric or alpha-numeric sub-codes.

72. A method according to claim 61, wherein said codes are stored together with links in electronic or other form, said links being usable for accessing or receiving said information.

73. A method according to claim 62, wherein the subcodes and/or codes are used to navigate to desired or associated links or information.

74. A method according to claim 62, wherein each of the sub-codes at each level of the hierarchical structure is associated with a certain subject-term.

75. A method according to claim 61, wherein each of the sub-codes at each level of the hierarchical structure is associated with a certain subject-term.

76. A method according to claim 64, wherein the codes consist solely of a combination of said sub-codes.

77. A method according to claim 61, wherein information assigned a particular code relates either:
i) to the subject-term associated with said particular code if the code includes a single sub-code; or
ii) to all subject-terms associated with all sub-codes of said particular code if the code includes more than one sub-code.

78. A method according to claim 62, wherein information assigned a particular code relates either:
i) to the subject-term associated with said particular code if the code includes a single sub-code; or
ii) to all subject-terms associated with all sub-codes of said particular code if the code includes more than one sub-code.

79. A method according to claim 62, wherein one or more of said codes are distributed together with information and/or products.

80. A method according to claim 62, wherein an indexing function is provided at each level of said hierarchical structure.

81. A method according to claim 80, wherein at each level of said hierarchical structure data related to subject-terms associated with the sub-codes are available upon entering a particular sub-code.

82. A method according to claim 61, wherein one or more of the sub-codes are converted into the associated subject-terms.

83. A method according to claim 62, wherein one or more of the sub-codes are converted into the associated subject-terms.

84. A method according to claim 83, wherein codes complemented by subject-terms are used to search for, access or receive information.

85. A method according to claim 84, wherein the code is complemented by a suffix or a prefix.

86. A method according to claim 85, whereby the suffix is used as a filter or to provide additional information.

87. A method according to claim 86, whereby the suffix includes one or more additional subject terms or sub-codes or symbols.

88. An apparatus for performing a search on a database or a network of databases, the apparatus being adapted to perform the method according to claim 44.

89. A database or a network of databases adapted to perform the method according to claim 44.

90. A computer program adapted to perform the method according to claim 44 when being executed on a computer.

91. A system for accessing information stored in a database or network of databases, the system comprising a terminal for entering said codes according to claim 44.
